(19) United States
(12) Patent Application Publication
(10) Pub. No.: US 2014/0176788 A1
(43) Pub. Date: Jun. 26, 2014

(54) ELECTRONIC DEVICE WITH CAMERA MODULE

(71) Applicant: HON HAI PRECISION INDUSTRY CO., LTD., New Taipei (TW)

(72) Inventor: SHU-YING CHEN, New Taipei (TW)

(73) Assignee: HON HAI PRECISION INDUSTRY CO., LTD., New Taipei (TW)

(21) Appl. No.: 13/952,806

(22) Filed: Jul. 29, 2013

(30) Foreign Application Priority Data
Dec. 26, 2012 (TW) 101150286

(51) Int. Cl. H04N 7/15; H04N 5/238

(52) U.S. Cl. CPC H04N 7/15; H04N 5/238
USPC 348/362

(57) ABSTRACT

An electronic device includes a casing, a camera module, a shielding plate, and an actuator. The casing includes a front plate and a sidewall extending from an outer periphery of the front plate. The front plate defines a through hole. The camera module is positioned on and received in the casing and aims at the through hole. The shielding plate is rotatably positioned on and received within the casing and located between the front plate and the camera module. The shielding plate defines an aperture. The actuator is positioned on and received in the casing for driving the shielding plate to rotate between a closed position, in which the through hole is shielded by the shielding plate, and an open position, in which the aperture is aligned with the through hole.

### BACKGROUND

1. Technical Field

The present disclosure relates to electronic devices and, particularly, to an electronic device having a camera module.

2. Description of Related Art

Many electronic devices include a camera module and can be used for video conferences. However, on some occasions, participants in the video conference may want to hide from view for a short time period for private discussions. In this case, the participant needs to disconnect from the video conference and then resume the connection, which is inconvenient.

Therefore, it is desirable to provide an electronic device that can overcome the above-mentioned problems.

### BRIEF DESCRIPTION OF THE DRAWINGS

Many aspects of the present disclosure can be better understood with reference to the following drawings. The components in the drawings are not necessarily drawn to scale, the emphasis instead being placed upon clearly illustrating the principles of the present disclosure.

FIG. 1 is a cross-sectional view of an electronic device, according to an embodiment.

FIG. 2 is an isometric exploded view of a casing and a shielding plate of the electronic device of FIG. 1.

FIG. 3 is an isometric view of the casing and the shielding plate of the electronic device of FIG. 1.

FIG. 4 is an isometric exploded view of the casing, the shielding plate, and an actuator of the electronic device of FIG. 1.

FIG. 5 is an isometric view of the actuator of the electronic device of FIG. 1.

FIG. 6 is an isometric view of the shielding plate and the actuator of the electronic device of FIG. 1.

### DETAILED DESCRIPTION

Embodiments of the present disclosure will be described with reference to the drawings.

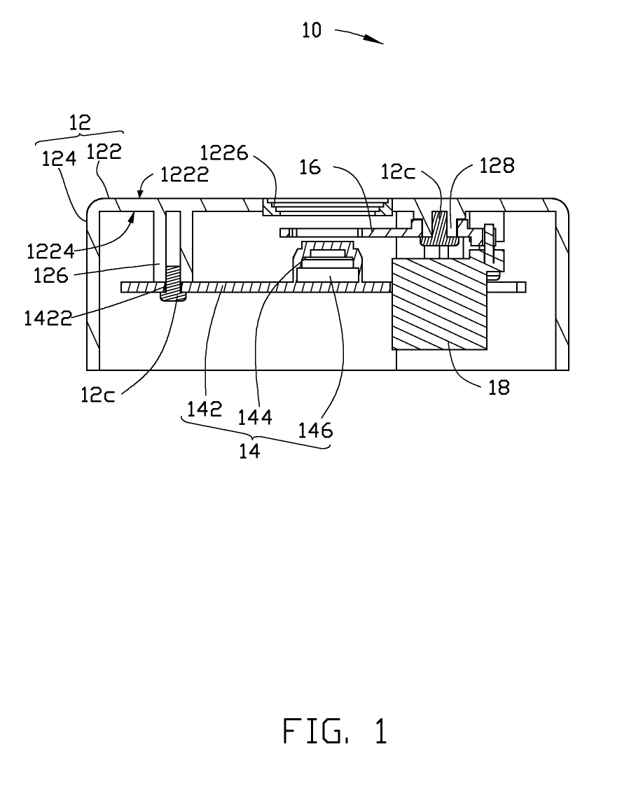

FIG. 1 shows an electronic device 10 according to an embodiment. The electronic device 10 includes a casing 12, a camera module 14, a shielding plate 16, and an actuator 18.

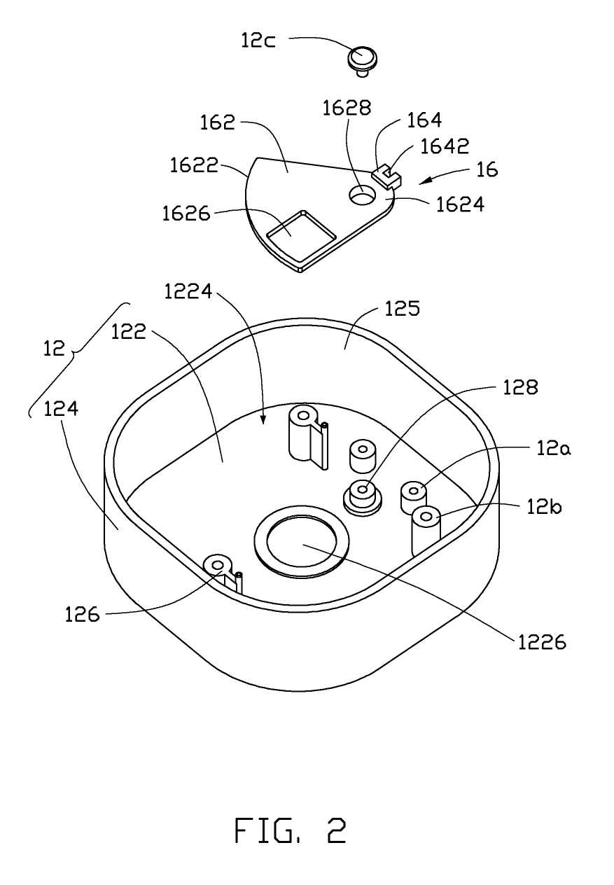

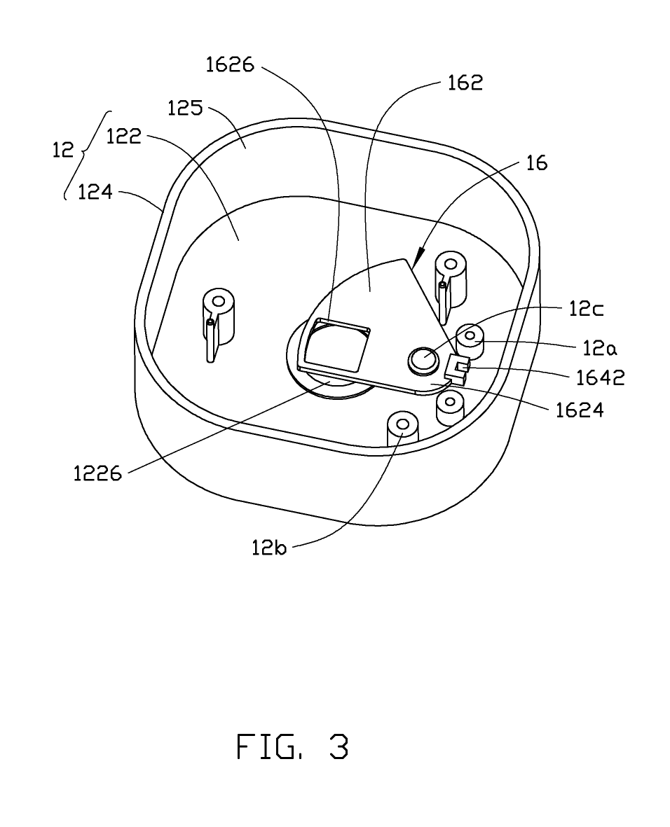

Also referring to FIGS. 2, 3, the casing 12 includes a substantially circular front plate 122 and a substantially annular sidewall 124 extending back from an outer periphery of the front plate 122. The front plate 122 and the sidewall 124 cooperatively define a receiving space 125. The front plate 122 includes a front surface 1222 facing away from the sidewall 124 and a back surface 1224 opposite to the front surface 1222, and defines a substantially circular through hole 1226 extending through central portions of the front surface 1222 and the back surface 1224.

The casing 12 also includes a first tube 126, a second tube 128, two third tubes 12a, and two fourth tubes 12b, all of which extend up from the back surface 1224 along a direction that is substantially perpendicular to the back surface 1224 and arranged around the through hole 1226. The casing 12 also includes a number of screws 12c. Each of the first to third tubes 126, 128, 12a is internally threaded for engaging with one of the screws 12c.

The first tube 126 and the second tube 128 are positioned at two diametrically opposite sides of the through hole 1226. The third tubes 12a are positioned at a side of the second tube 128 opposite to the first tube 126 and substantially symmetrical to each other about a line passing through centers of the first tube 126 and the second tube 128. The fourth tubes 12b are linearly arranged with the second tube 128 and substantially symmetrical to each other about the line passing through centers of the first tube 126 and the second tube 128. A distance between the fourth tubes 12b is longer than a distance between the third tubes 12a.

The camera module 14 includes a printed circuit board 142, a lens module 144, and an image sensor 146. The printed circuit board 142 defines a threaded hole 1422. The lens module 144 and the image sensor 146 are positioned on the printed circuit board 142 and the lens module 144 covers the image sensor 146.

The shielding plate 16 includes a substantially fan-shaped plate 162 that includes an arced end 1622 and an apex 1624. The plate 162 defines a substantially rectangular aperture 1626 in the arced end 1622 and a fixing hole 1628 in the apex 1624. The shielding plate 16 also includes an engaging block 164 fixed to the apex 1624. The engaging block 164 defines a slot 1642 in a side surface of the engaging block 164 facing away from the plate 162 and extending through the engaging block 164 along a direction that is substantially perpendicular to the plate 162.

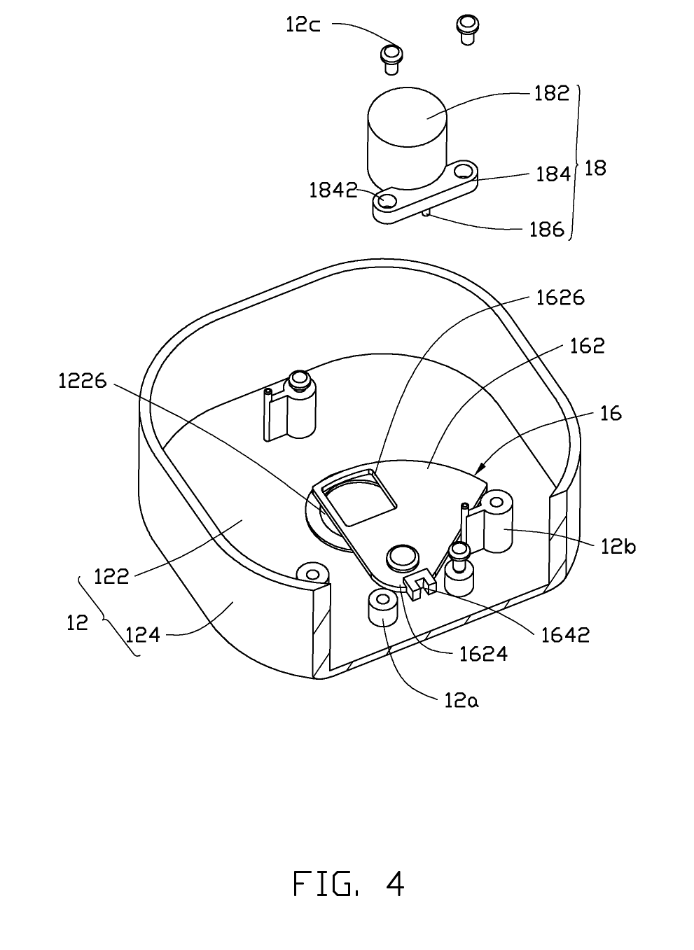

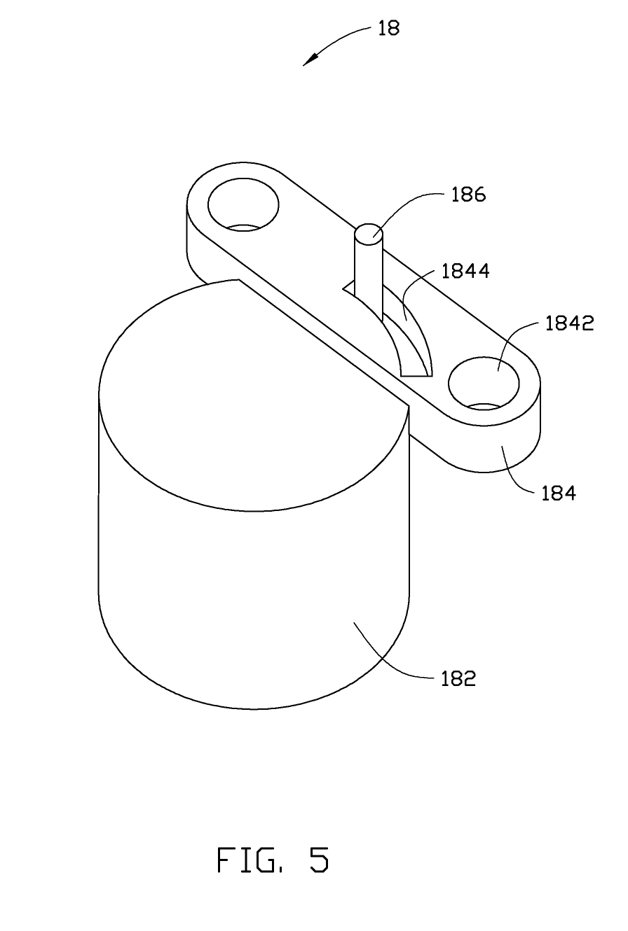

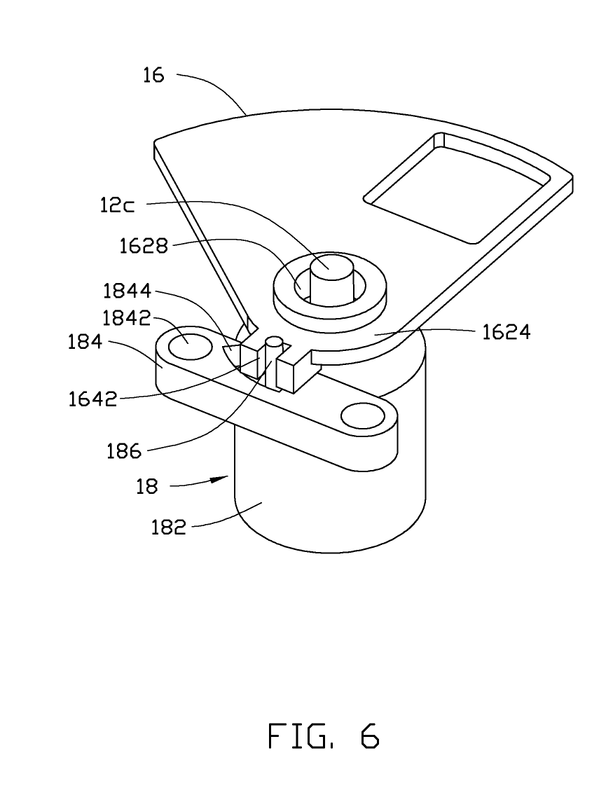

Referring to FIGS. 4-6, the actuator 18 includes a substantially cylindrical stator body 182, a support strip 184, and a shaft 186. One end of the stator body 182 is fixed to and supported by the support strip 184. The support strip 184 defines two securing holes 1842 in two opposite ends and an arced guiding slot 1844 in a central portion thereof. The shaft 186 protrudes from the stator body 182 and extends through the guiding slot 1844. The stator body 182 drives the shaft 186 to move along a path defined by the guiding slot 1844.

In assembly, the shielding plate 16 is received in the casing 12, i.e., the receiving space 125, and located between the fourth tubes 12b. The fixing hole 1628 is aligned with the second tube 128. One of the screws 12c is screwed through the fixing hole 1628 and into the second tube 128, thus rotatably fixing the shielding plate 16 to the casing 12. A rotation range of the shielding plate 16 is limited by the fourth tubes 12b. A position where the shielding plate 16 abuts one of the fourth tubes 12b and the through hole 1226 is shielded by the shielding plate 16 is defined as a closed position. Another position where the shielding plate 16 abuts the other fourth tube 12b and the aperture 1626 is aligned with the through hole 1226 is defined as an open position.

The actuator 18 is received in the casing 12, i.e., the receiving space 125, and the support strip 184 is positioned across the third tubes 12a. The securing holes 1842 are aligned with the third tubes 12a. The shaft 186 inserts into the slot 1642. Two of the screws 12c are screwed into the securing holes 1842 and into the third tubes 12a. Thus, the actuator 18 is fixed to the casing 12 and can drive the shielding plate 16 to rotate between the closed position and the open position.

The camera module 14 is received in the receiving space 125. The shielding plate 16 is positioned between the camera module 14 and the front plate 122. The threaded hole 1422 is aligned with the first tube 126 thus aiming the lens module 144 at the through hole 1226. One of the screws 12c is screwed the threaded hole 1422 and into the first tube 126. Thus, the printed circuit board 142, along with the whole camera module 14, is fixed to the casing 12 and aims at the through hole 1226.

In operation, the electronic device 10 can be used for video conferences. The shielding plate 16 is driven to the open position. As such, the camera module 14 can receive light from outside the casing 12 through the aperture 1626 and the through hole 1226. For privacy, the camera module 14 can be shielded by having the actuator 18 drive the shielding plate 16 to the closed position.

The electronic device 10 can include a switch (not shown) operable to activate the switching of the shielding plate 16 between the closed position and the open position.

It will be understood that the above particular embodiments are shown and described by way of illustration only. The principles and the features of the present disclosure may be employed in various and numerous embodiments thereof without departing from the scope of the disclosure. The above-described embodiments illustrate the possible scope of the disclosure but do not restrict the scope of the disclosure.

What is claimed is:

1. An electronic device, comprising:
a casing comprising a front plate and a sidewall extending from an outer periphery of the front plate, the front plate defining a through hole;
a camera module positioned on and received in the casing and aiming at the through hole;
a shielding plate rotatably positioned on and received within the casing and located between the front plate and the camera module, the shielding plate defining an aperture; and
an actuator positioned on and received in the casing for driving the shielding plate to rotate between a closed position and an open position, in the closed position, the through hole is shielded by the shielding plate, and in the open position, the aperture is aligned with the through hole.

2. The electronic device of claim 1, wherein the front plate comprises a front surface and a back surface opposite to the front surface, the casing comprises an internally threaded first tube extending from the back surface, the camera module comprises a printed circuit board, a lens module, and an image sensor, both of the lens module and the image sensor are positioned on the printed circuit board, the lens module covers the image sensor, the printed circuit board defines a threaded hole, the electronic device comprises a first screw screwing through the threaded hole and into the first tube thus fixing the camera module to the casing and aiming the lens module to the through hole.

3. The electronic device of claim 2, wherein the casing comprises an internally threaded second tube, the first tube and the second tube are positioned at two diametrically opposite sides of the through hole, the shielding plate comprises a substantially fan-shaped plate that comprises an arced end and an apex, the plate defines a substantially rectangular aperture in the arced end and a fixing hole in the apex, the casing further comprises a second screw screwing through the fixing hole and into the second tube to rotatably fix the shielding plate to the casing.

4. The electronic device of claim 3, wherein the casing comprises two internally threaded third tubes, the third tubes are positioned at a side of the second tube opposite to the first tube and substantially symmetrical to each other about a line passing through centers of the first tube and the second tube, the shielding plate comprises an engaging block fixed to the apex, the engaging block defines a slot in a side surface of the engaging block facing away from the plate and extending through the engaging block along a direction that is substantially perpendicular to the plate, the actuator comprises a substantially cylindrical stator body, a support strip, and a shaft, one end of the stator body is fixed to and supported by the support strip, the support strip defines two securing holes in two opposite ends and an arced guiding slot in a central portion thereof, the shaft protrudes from the stator body and extends through the guiding slot, the stator body is configured to drive the shaft to move along a path defined by the guiding slot, the casing comprises two third screws screwing through the securing holes and into the third tubes thus to fix the actuator to the casing and engage the shaft with the slot.

5. The electronic device of claim 4, wherein the casing comprises two fourth tubes, the fourth tubes are linearly arranged with the second tube and substantially symmetrical to each other about the line passing through centers of the first tube and the second tube, a distance between the fourth tubes is longer than a distance between the third tubes.

6. The electronic device of claim 5, wherein a rotation range of the shielding plate is limited by the fourth tubes.
